(19) United States
(12) Patent Application Publication
(10) Pub. No.: US 2007/0055636 A1
(43) Pub. Date: Mar. 8, 2007

(54) Cellular minigrid

(76) Inventors: Colin Chambers, Chatswood (AU); Steve Kavanagh, Hunters Hill (AU)

Correspondence Address: LADAS & PARRY LLP, 224 SOUTH MICHIGAN AVENUE, SUITE 1600, CHICAGO, IL, 60604, US

(21) Appl. No.: 10/553,331

(22) PCT Filed: Apr. 15, 2004
(86) PCT No.: PCT/AU04/00497

§ 371 Date: Jan. 12, 2006

(30) Foreign Application Priority Data
Apr. 15, 2003 (AU) 2003901784
Feb. 2, 2004 (AU) 2004900466

(51) Int. Cl. G06Q 99/00

(52) U.S. Cl. 705/80

(57) ABSTRACT

A system (1) for transferring a resource within an area (3) having a plurality of regions (5), the system (1) comprising: determining means (15) operable to determine whether any one or more of the regions (5) requires an amount of the resource; requesting means (15) operable to issue a request to at least one of the regions (5) for the amount of the resource; and transferring means (13) operable to transfer the resource from the at least one of the regions (5) to the any one or more of the regions (5).

### FIELD OF THE INVENTION

The present invention relates generally to a cellular minigrid, and more particularly to systems and a method for transferring a resource in a decentralised resource network having an area comprising a plurality of regions.

### BACKGROUND OF THE INVENTION

Traditional systems used to distribute a resource, such as an electrical power system, employ a centralised architecture. In the case of an electrical power system, this means that it employs a centrally located power plant that is connected to a series of transmission lines that distribute electricity from the power plant to consumers.

In the case of an electrical power system, the centralised architecture has several drawbacks including: inefficiency due to power losses in the transmission lines; difficulty in extending the system into new areas as this can require an expensive system upgrade and the purchase of land; and is often susceptible to outages due to the centralized nature of the power plant.

The drawbacks associated with a centralised architecture can be avoided by adopting a decentralised architecture (sometimes referred to as a decentralised resource network). In a decentralised architecture, an area (such as a suburb) is divided into a number of distinct conceptual regions/cells, which are typically defined by the boundaries of districts in the suburb. Each region can be, for example, defined by a number of intersecting streets. Each region has its own generating and distribution means (for example, electricity generator) which generates and supplies the resource to consumers located within the associated region.

In order to keep the infrastructure costs of a decentralised architecture to a minimum, it is desirable to use resource generators that have a maximum resource output that is equal to the expected peak demand for the resource. Whilst this characteristic keeps infrastructure costs to a minimum, it does mean that an additional supply of the resource may need to be obtained elsewhere when a region's demand for the resource exceeds the respective generator's maximum output of the resource.

### SUMMARY OF THE INVENTION

According to a first aspect of the present invention, there is provided a system for transferring a resource within an area having a plurality of regions, the system comprising:

determining means operable to determine whether any one or more of the regions requires an amount of the resource;

requesting means operable to issue a request to at least one of the regions for the amount of the resource; and

transferring means operable to transferring the resource from the at least one of the regions to the any one or more of the regions.

Thus, the system has an advantage of being able to locate and provide an additional source of the resource from other regions in the area. This is desirable in order to avoid the expense associated with upgrading the generators in those regions that may only require the additional supply of a temporary or ad hoc basis.

Preferably, the determining means is operable to determine whether any one or more of the regions requires the amount of the resource by determining whether a supply of the resource is adequate for any one or more of the regions.

Preferably, the determining means is operable to determine whether any one or more of the regions requires the amount of the resource by determining whether a source from which the supply of the resource is obtained is operational. The determining means is also preferably operable to determine whether the source is operational by monitoring a status of the source.

Preferably, the determining means is operable to determine whether the supply of the resource is adequate by determining whether a demand for the resource is likely to exceed a maximum amount which the supply of the resource can provide. The determining means is also operable to determine whether the demand exceeds the maximum amount by monitoring an output of the source.

Preferably, the determining means comprises an electronic monitoring device which is operable to collect information about the status and the output of the source, the monitoring device also being operable to process the information in order to determine whether the demand exceeds the maximum amount, and to determine the status of the source.

Preferably, the requesting means comprises a plurality of interconnected devices each of which is associated with a respective one of the regions, each of the devices being operable to issue the request to any other devices which are connected thereto, thereby effecting issue of the request to the at least one of the regions.

Preferably, each of the devices is such that upon receiving the request they determine whether the respective one of the regions is capable of providing the amount of the resource.

Preferably, each of the devices is operable to issue an indication that the respective one of the regions is capable of providing the amount of the resource.

Preferably, each of the devices is operable to determine whether the respective one of the regions has a surplus amount of the resource, to thereby effect determining of whether the respective one of the regions is capable of providing the amount of the resource.

Preferably, each of the devices is operable to determine whether a demand for the resource in the respective one of the regions is likely to exceed a maximum amount which the supply of the resource can provide to the respective one of the regions, to thereby effect determination of whether the respective one of the regions has the surplus amount of the resource.

Preferably, the transferring means comprises a plurality of links that can be arranged in a mesh topology, and which can be used to transfer the resource from the at least one of the regions to the any one or more of the regions.

Preferably, the system is arranged to be used in a decentralized architecture.

According to a second aspect of the present invention, there is provided a method for transferring a resource within an area having a plurality of regions, the method comprising the steps of:

determining whether any one or more of the regions requires an amount of the resource;

issuing a request to at least one of the regions for the amount of the resource; and

transferring the resource from the at least one of the regions to the any one or more of the regions.

Preferably, the step of determining whether the any one or more of the regions requires the amount of the resource comprises the step of determining whether a supply of the resource is adequate for the any one or more of the regions.

Preferably, determining whether the any one or more of the regions requires the amount of the resource comprises determining whether a source from which the supply of the resource is obtained is operational. The step of determining whether the source is operational preferably comprises monitoring a status of the source.

Preferably, determining whether the supply of the resource is adequate comprises determining whether a demand for the resource is likely to exceed a maximum amount which the supply of the resource can provide. The step of determining whether the demand exceeds the maximum amount preferably comprises monitoring an output of the source.

Preferably, determining whether the source is operational and/or whether the demand exceeds the maximum amount comprises collecting information about the status and the output of the source, and processing the information in order to determine whether the demand exceeds the maximum amount and the status of the source.

Preferably, issuing the request comprises determining whether the respective one of the regions is capable of providing the amount of the resource.

Preferably, issuing the request comprises issuing an indication that the respective one of the regions is capable of providing the amount of the resource.

Preferably, transferring the resource comprises arranging a plurality of links into a mesh topology, and using the links to transfer the resource from the at least one of the regions to the any one or more of the regions.

According to a third aspect of the present invention there is provided a decentralised resource network, the decentralised resource network comprising:

a plurality of geographically dispersed sub-networks each of which comprises a generator capable of generating a resource and a local distribution system arranged to distribute the resource to consumers;

a generator control system operable to: identify a first of the sub-networks that does not have the capacity to provide an amount of the resource required by the consumers; and change an operational status of the generator of a second of the sub-networks so as to produce the amount of the resource; and

a backbone distribution system arranged to transfer the amount of the resource from the first of the sub-networks to the second of the sub-networks.

Thus, by virtue of the generator control system the generators in the sub-networks can be adjusted (change in operational status) to produce the amount of the resource only when required—which results in efficient operation of the generators. Existing decentralised resource networks typically run the generators to produce the amount of the resource irrespective of whether the amount of the resource is required, which often results in inefficient operation of the generators.

Preferably, the generator control system is operable to select the second of the sub-networks based on proximity of the second of the sub-networks to the first of the sub-networks.

Thus, selecting the second of the sub-networks based on the proximity is advantageous because it enables the second of the sub-networks to be as close as possible to the first of the sub-networks. This is desirable because it assists in minimising transmission losses which the amount of the resource may experience as a result of being transferred from the second of the sub-networks to the first of the sub-networks via the backbone distribution system.

Preferably, the generator control system comprises:

a local control system;

a communication means; and

a global controller,

wherein the local control system is operable to collect status information about a status of the generator in each of the sub-networks and use the communication means to transfer the information to the global controller, the global controller being operable to process the status information in order to identify the first of the sub-networks and send status control data to the local control system via the communication means, the local control system being operable to process the status control data in order to effect the change in the operational status of the generator in the second of the sub-networks.

Preferably, the backbone distribution system comprises a plurality of resource transmission links arranged in a mesh topology.

Thus, an advantage of having the resource transmission links arranged in the mesh topology is that it provides a level of protection against the failure of some of the resource transmission links. Consequently, if some of the resource transmission links fail then other resource transmission links can be used to transfer the amount of the resource to the second of the sub-networks.

According to a fourth aspect of the present invention, there is provided computer software which, when executed by a computing system, allows the computing system to carry out the method according to the second aspect of the present invention.

According to a fifth aspect of the present invention, there is provided a computer readable medium comprising the software according to the third aspect of the present invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 illustrates a decentralised resource network that embodies the present invention;

FIG. 2 illustrates an other decentralised resource network that embodies the present invention;

FIG. 3 provides a flow chart of the various steps performed by the decentralised resource network illustrated in figure; and

FIG. 4 provides a flow chart of the various steps performed by the decentralised resource network illustrated in FIG. 2.

### AN EMBODIMENT OF THE PRESENT INVENTION

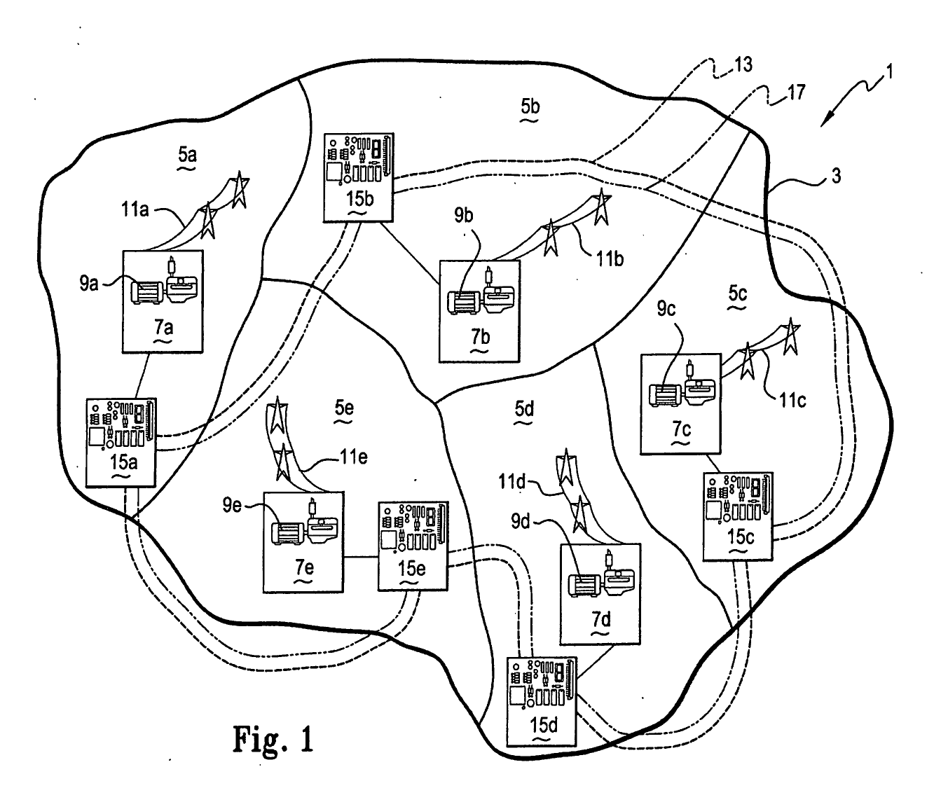

FIG. 1 illustrates a decentralised resource network 1 that embodies the present invention. The decentralised resource network 1 is arranged to provide consumers in an area 3 with electricity. The area 3 is divided into a number of regions 5. The area 3 is, for example, a suburb, while the regions 5 are, for example, different districts within the suburb.

Unlike traditional resource networks that employ a centralised electricity generation plant, the decentralised resource network 1 comprises a plurality of geographically dispersed sub-networks 7, each of which is located in or near one of the regions 5. The sub-networks 7 are capable of providing a supply of electricity to consumers located in the respective regions 5. Each of the sub-networks 7 comprises a generator 9 for generating electricity and a local distribution system 11 for distributing electricity from the generator 9 to the consumers in the respective region 5. Each generator 9 is in the form of a reciprocating petrol engine driven generator. It is also envisaged that other embodiments of the present invention comprise other forms of the generator 9. Furthermore, each generator 9 is selected such that it has maximum electricity output is capable of meeting an expected demand for the electricity in the respective region 5. The local distribution system 11 is in the form of a plurality of electricity transmission lines.

In addition to the sub-networks 7, the decentralised resource network 1 comprises a backbone distribution system 13. The backbone distribution system 13 is in the form of a plurality of electricity transmission lines and is arranged such that the local distribution systems 11 are interconnected to each other. The backbone distribution system 13 effectively enables electricity from the sub-networks 7 to be transferred between each other. To provide a level of protection against the failure of the transmission links in the backbone distribution system 13, the transmission links of the backbone distribution system 13 are arranged in a mesh topology. It will be appreciated, however, that the transmission links of the backbone can be arranged to form other topologies such as a star topology.

The decentralised resource network 1 also comprises a plurality of local controllers 15. Each local controller 15 is ‘assigned’ to one of the regions 5 and is operable to determine whether the region 5 to which it has been assigned requires an amount of electricity that the generator 9 for the assigned region 5 is not capable of supplying. More specifically, each local controller 15 is operable to determine whether the assigned region 5 requires the amount of the electricity by ascertaining whether the assigned region 5 has an adequate supply of electricity and/or whether the generator 9 of the assigned region 5 is operational. To determine whether a region 5 has an adequate supply of electricity, the local controller 15 assigned to the region 5 determines whether the region 5 is likely to have a demand for electricity that will exceed a maximum amount of the electricity that the generator 9 of the assigned region 5 can supply.

To carry out the previously mentioned functions, each local controller 15 comprise a data processing circuit and a sensor circuit (both of which are not illustrated in the figures). The data processing circuit and sensor circuit are interconnected to each other. The sensor circuit is operable to monitor the demand (load) placed on the generator 9 of the assigned region 5 by the consumers therein. Furthermore, the sensor circuit monitors the operational status of the generator 9 in the assigned region 5. The sensor circuit collects information about the load and operational status of the generator 9 and forwards the collected information to the processing circuit. Upon receiving the information, the processing circuit processes the information to determine whether the demand for the resource is likely to exceed the maximum amount of the resource which the generator 9 of the region 5 can provide, and whether the generator 9 of the region 5 is operational.

The processing circuit of each local controller 15 is also operable to issue a request to one or more other local controllers 15 upon determining that the region 5 to which the local controller 15 has been assigned requires the amount of electricity. The request itself indicates that the region 5 to which a local controller 15 has been assigned requires the amount of electricity.

To enable the local controller 15 to issue the request, the decentralised resource network 1 comprises a local area network 17 (LAN). The processing circuit of each local controller 15 is such that it is capable of using the LAN 17 to issue the request in the form of a data packet which is transmitted on the LAN 17.

The processing circuit of each local controller 15 is operable to ‘listen’ to the LAN 17 for the data packet representing the request. On detecting the data packet representing the request, the processing circuit of the local controller 15 determines whether the generator 9 of the assigned region 5 is capable of providing the amount of requested electricity. Each local controller 15 does this by determining whether the generator 9 of the assigned region 5 has the capacity to supply the amount of requested electricity. Each local controller 15 is such that if they determine that the generator 9 of the assigned region 5 does not have the capacity to supply the amount of requested electricity, the local controller 15 forwards on the data packet (representing the request for the amount of electricity) to the local controllers 15 assigned to adjacent regions 5. The local controllers 15 to which the data packet is forwarded onto carry out the previously outlined steps for responding to a request for the amount of the resource. On the other hand, if a local controller 15 determines that the generator 9 of the assigned region 5 has the capacity to supply the requested amount of electricity, the processing circuit of the local controller 15 creates a data packet indicating that the generator 9 has the capacity to supply the amount of required electricity. The data packet, indicating that a generator 9 has the capacity to supply the resource, is placed on the LAN 17 by a local controller 15 so that it can be propagated back to the local controller 15 that originally issued the request for the amount of electricity.

Each local controller 15 is such that the processing circuit determines whether the generator 9 of the assigned region 5 has the capacity to supply the amount of electricity by monitoring a demand for the electricity in the assigned region 5, and determining whether the demand is likely to exceed a maximum amount of electricity that the generator 9 of the assigned region 5 can supply. This is achieved by the processing circuit processing information from the sensor circuit to determine whether the demand will exceed a maximum amount of the resource from the generator 9.

The backbone distribution system 13 and the local controllers 15 interact with each such that as the data packet, indicating that a generator 9 has the capacity to supply the amount of electricity, is propagated back to the local controller 15 that originally generated the request, a suitable path in the backbone distribution system 13 is established. Once the path has been established, the backbone distribution network 13 transfers the amount of requested electricity from a generator 9 to a local distribution system 11 for use by the consumers connected thereto.

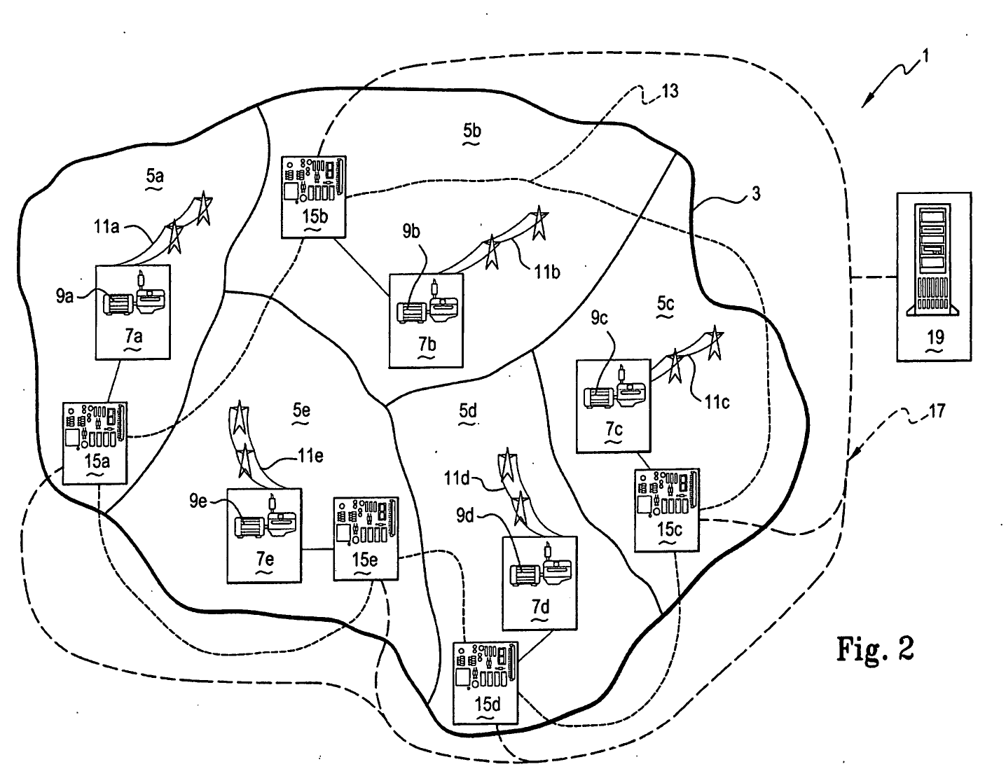

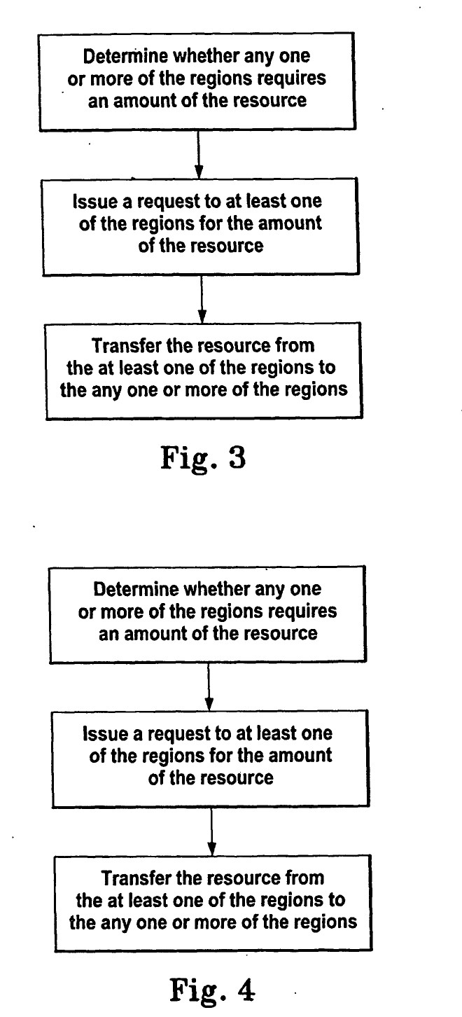

In an alternative embodiment of the present invention (which is depicted in FIG. 2), the decentralised resource network 1 comprises a global controller 19 in the form of an electronic processing circuit. In the alternative embodiment, each local controller 15 periodically sends to the global controller 19 information regarding the usage of electricity in the region 5 to which the local controller 15 has been assigned. The local controllers 15 use the LAN 17 to send the information to the global controller 19. On receiving the information via the LAN 17, the global controller 19 processes the information to determine whether any of the regions 5 require an additional amount of electricity. On determining that one or more of the regions 5 require the additional amount of electricity, the global controller 19 selects one or more of the generators 9 that has the capacity to supply the additional amount of electricity, and issues status control data to the local controllers 17 assigned to the regions 5 that have the generator(s) 9 that have the capacity to supply the additional amount of electricity. On receiving the status control data the local controller 15 effects a change in the operational status of the generator(s) 9 to bring about the additional amount of electricity. Typically, this involves increasing the RPM of the reciprocating petrol motor of the generator 9.

The backbone network 13 is operable such that the amount of electricity generated by changing the operational status of the generator 9 will be fed into the backbone distribution system 13 for use in the region 9 that requires it.

The global controller 19 is such that when the additional amount of electricity is no longer required, it issues further status control data to the appropriate local controller 15 (via the LAN 17) to restore the operational status of the generator(s) 9 back to its original status, which typically involves reducing the RPM of the reciprocating petrol motor.

It will be readily appreciated by those skilled in the art that whilst the described embodiments of the present invention are in the context of supplying electricity, the present invention has application to a range of different resources such as gas and water. When applied to resources other than electricity the local distribution system 13 and the backbone distribution system 15 would need to be appropriate for transferring the resource in question. For instance, if the present invention was applied to gas then the distribution systems 11 and 13 would comprises a series of connected pipes.

Those skilled in the art will appreciate that the invention described herein is susceptible to variations and modifications other than those specifically described. It should be understood that the invention comprises all such variations and modifications which fall within the spirit and scope of the invention.

1. A system for transferring a resource within an area having a plurality of regions the system comprising:
determining means operable to determine whether any one or more of the regions requires an amount of the resource;
requesting means operable to issue a request to at least one of the regions for the amount of the resource; and
transferring means operable to transfer the resource from the at least one of the regions to the any one or more of the regions.

2. The system as claimed in claim 1, wherein the determining means is operable to determine whether any one or more of the regions requires the amount of the resource by determining whether a supply of the resource is adequate for any one or more of the regions.

3. The system as claimed in claim 1, wherein the determining means is operable to determine whether any one or more of the regions requires the amount of the resource by determining whether a source from which the supply of the resource is obtained is operational.

4. The system as claimed in claim 2, wherein the determining means is operable to determine whether the supply of the resource is adequate by determining whether a demand for the resource is likely to exceed a maximum amount which the supply of the resource can provide.

5. The system as claimed in claim 3, wherein the determining means is operable to determining whether the source is operational by monitoring a status of the source.

6. The system as claimed in claim 4, wherein the determining means determines whether the demand exceeds the maximum amount by monitoring an output of the source.

7. The system as claimed in claim 6, wherein the determining means comprises an electronic monitoring device which is capable of collecting information about the status and the output of the source, the monitoring device being capable of processing the information in order to determine whether the demand exceeds the maximum amount and the status of the source.

8. The system as claimed in claim 7, wherein the requesting means comprises a plurality of interconnected devices each of which is associated with a respective one of the regions, each of the devices being capable of issuing the request to any other devices which are connected thereto, thereby effecting issue of the request to the at least one of the regions.

9. The system as claimed in claim 8, wherein each of the devices is such that upon receiving the request they determine whether the respective one of the regions is capable of providing the amount of the resource.

10. The system as claimed in claim 8, wherein each of the devices is capable of issuing an indication that the respective one of the regions is capable of providing the amount of the resource.

11. The system as claimed in claim 10, wherein each of the devices is capable of determining whether the respective one of the regions has a surplus amount of the resource, to thereby effect determining of whether the respective one of the regions is capable of providing the amount of the resource.

12. The system as claimed in claim 11, wherein each of the devices is capable of determining whether a demand for the resource in the respective one of the regions is likely to exceed a maximum amount which the supply of the resource can provide to the respective one of the regions, to thereby effect determination of whether the respective one of the regions has the surplus amount of the resource.

13. The system as claimed in claim 12, wherein the transferring means comprises a plurality of links which are arranged in a mesh topology, and which can be used to transfer the resource from the at least one of the regions to the any one or more of the regions.

14. A method for transferring a resource within an area having a plurality of regions, the method comprising the steps:
determining whether any one or more of the regions requires an amount of the resource;
issuing a request to at least one of the regions for the amount of the resource; and
transferring the resource from the at least one of the regions to the any one or more of the regions any one or more of the regions to the first of the regions.

15. The method as claimed in claim 14, wherein determining whether the any one or more of the regions requires the amount of the resource comprises determining whether a supply of the resource is adequate for the any one or more of the regions.

16. The method as claimed in claim 15, wherein determining whether the any one or more of the regions requires the amount of the resource comprises determining whether a source from which the supply of the resource is obtained is operational.

17. The method as claimed in claim 15, wherein determining whether the supply of the resource is adequate comprises determining whether a demand for the resource is likely to exceed a maximum amount which the supply of the resource can provide.

18. The method as claimed in claim 16, wherein determining whether the source is operational comprises monitoring a status of the source.

19. The method as claimed in claim 17, wherein determining whether the demand exceeds the maximum amount comprises monitoring an output of the source.

20. The method as claimed in claim 19, wherein determining whether the source is operational and/or whether the demand exceeds the maximum amount comprises collecting information about the status and the output of the source, and processing the information in order to determine whether the demand exceeds the maximum amount and the status of the source.

21. The method as claimed in claim 14, wherein issuing the request comprises determining whether the respective one of the regions is capable of providing the amount of the resource.

22. The method as claimed in claim 14, wherein issuing the request comprises issuing an indication that the respective one of the regions is capable of providing the amount of the resource.

23. The method as claimed in claim 14, wherein transferring the resource comprises arranging a plurality of links into a mesh topology, and using the links to transfer the resource from the at least one of the regions to the any one or more of the regions.

24. A decentralised resource network, the network comprising:
a plurality of geographically dispersed sub-networks each of which comprises a generator capable of generating a resource and a local distribution system arranged to distribute the resource to users;
a generator control system operable to: identify a first of the sub-networks that that is not capable of providing an amount of the resource required by the users;
and change an operational status of the generator of a second of the sub-networks so as to produce the amount of the resource; and
a backbone distribution system arranged to transfer the amount of the resource from the first of the sub-networks to the second of the sub-networks.

25. The decentralised resource network as claimed in claim 24, wherein the generator control system is operable to select the second of the sub-networks based on a proximity of the second of the sub-networks to the first of the sub-networks.

26. The decentralised resource network as claimed in claim 24, wherein the generator control system comprises:
a local control system;
a communication means; and
a global controller, wherein the local control system is operable to collect status information about a status of the generator in each of the sub-networks and use the communication means to transfer the information to the global controller, the global controller being operable to process the status information in order to identify the first of the sub-networks and send status control data to the local control system via the communication means, the local control system being operable to process the status control data in order to effect the change in the operational status of the generator in the second of the sub-networks.

27. The decentralised resource network as claimed in claim 24, wherein the backbone distribution system comprises a plurality of resource transmission links arranged in a mesh topology.

28. Computer software which, when executed by a computing system, allows the computing system to carry out the method as claimed in any one of claims 14 to 23.

29. A computer readable medium comprising the software as claimed in claim 28.
